(19) United States
(12) Patent Application Publication
(10) Pub. No.: US 2016/0075056 A1
(43) Pub. Date: Mar. 17, 2016

(54) FIBER COMPOSITE MATERIAL MICROWAVE CURING DEVICE WITH AN ENDLESS CONVEYOR BELT AND A METHOD FOR CURING COMPOSITE MATERIAL USING THE MICROWAVE CURING DEVICE

(71) Applicant: Ching-Long ONG, TAICHUNG CITY (TW)

(72) Inventor: Ching-Long ONG, TAICHUNG CITY (TW)

(21) Appl. No.: 14/487,033

(22) Filed: Sep. 15, 2014

(51) Int. Cl. B29C 35/08; H05B 6/78; H05B 6/80; B29C 70/44

(52) U.S. Cl. CPC B29C 35/0805; B29C 70/44; H05B 6/78; H05B 6/80; B29C 2035/0855; B29K 2105/089

(57) ABSTRACT

A fiber composite material microwave curing device with an endless conveyor belt includes an input area and an output area, and a tunnel microwave device disposed above the belt and located between the input and output areas. The tunnel microwave device includes an input port and an output port. A method for curing fiber composite material using the microwave curing device includes: putting a fiber cloth containing an impregnated material into a mold, covering the mold with a sealing bag and vacuuming the sealing bag; placing the vacuumed mold in the input area, using the belt to move the to-be-treated object to the input port; using the tunnel microwave device to heat the vacuumed mold to 80-400° C. within 5-30 seconds; and moving the mold from the output port to the output area, taking out the mold from the sealing bag, then taking out a final product from the mold.

### BACKGROUND OF THE INVENTION

1. Field of the Invention

The present invention relates to a fiber composite material, and more particularly to a fiber composite material microwave curing device with an endless conveyor belt, and a method for curing the composite material using the microwave curing device.

2. Description of the Prior Art

Microwave curing of fiber composite material is a process to cure the fiber composite material by using the heat produced by coupling of microwave and fiber composite material, which has the advantages of quick response, energy saving, selective heating, and quick high temperature. Conventional devices for curing the fiber composite material are mostly a microwave oven with an opening The to-be-cured fiber composite material is pretreated (such as impregnant) and then fed into the microwave oven via the opening, after being heated for a certain period of time in the microwave oven, the fiber composite material is taken out, and thus the microwave curing process is finished.

The fiber composite material has to be fed into the oven via the opening during the microwave curing process, and then has to be taken out of the oven via the same the opening after the microwave curing process. Therefore, the microwave curing process can not be carried out in a continuous manner.

The present invention has arisen to mitigate and/or obviate the afore-described disadvantages.

### SUMMARY OF THE INVENTION

The primary objective of the present invention is to provide a fiber composite material microwave curing device with an endless conveyor belt, and a method for curing the composite material using the microwave curing device, which are capable of improving curing efficiency.

To achieve the above objective, a fiber composite material microwave curing device with an endless conveyor belt in accordance with the present invention, comprises: the conveyor belt driven to rotate by a motor and including an input area and an output area; and a tunnel microwave device disposed above the upper portion of the belt of the conveyor belt and located between the input and output areas. The tunnel microwave device is arc-shaped to form an input port and an output port which are located toward the input and output areas, respectively.

To achieve the above objective, a method for curing fiber composite material using the fiber composite material microwave curing device comprises the following steps:

a first step of putting a fiber cloth containing an impregnated material into a mold, covering the mold with a sealing bag, and vacuuming the sealing bag to a rough vacuum state;

a second step of placing the mold which has been vacuumed to a rough vacuum state by the sealing bag in the input area of the conveyor belt, so that the to-be-treated object is moved by the convey belt to the input port of the tunnel microwave device;

a third step of using the tunnel microwave device to heat the mold which has been vacuumed to a rough vacuum state by the sealing bag to 80-400° C. within 5-30 seconds, so as to cure the fiber cloth containing the impregnated material; and

a fourth step of moving the mold which has been vacuumed to a rough vacuum state by the sealing bag from the output port of the tunnel microwave device to the output area of the convey belt, taking out the mold from the sealing bag, then taking out a final product from the mold.

The present invention is characterized in that the tunnel microwave device is provided with an input port and an output port, and the conveyor belt is capable of continuously moving to-be-treated object from the input port to the output, so that the to-be-treated objects can be processed by the microwave curing device in a continuous manner. Furthermore, since the composite material inside the mold is heated by variable frequency microwave, which can keep the mold in a low temperature for easy and safe removal of the final product.

### BRIEF DESCRIPTION OF THE DRAWINGS

FIG. 1 is a cross sectional view of a fiber composite material microwave curing device with an endless conveyor belt in accordance with a preferred embodiment of the present invention;

FIG. 2 is a flow chart illustrating the conveyor belt of the present invention;

FIG. 3 is a flow chart showing the steps of a method for curing fiber composite material using the microwave curing device with the endless conveyor belt in accordance with the invention;

FIG. 4 is a cross sectional view of a fiber composite material microwave curing device with an endless conveyor belt in accordance with another preferred embodiment of the present invention; and

FIG. 5 is a side view of FIG. 4.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

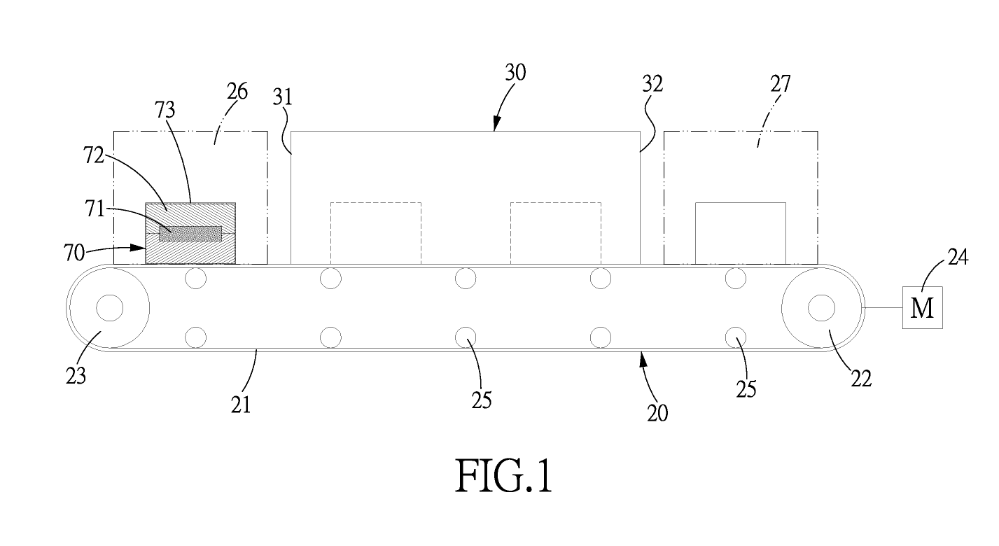

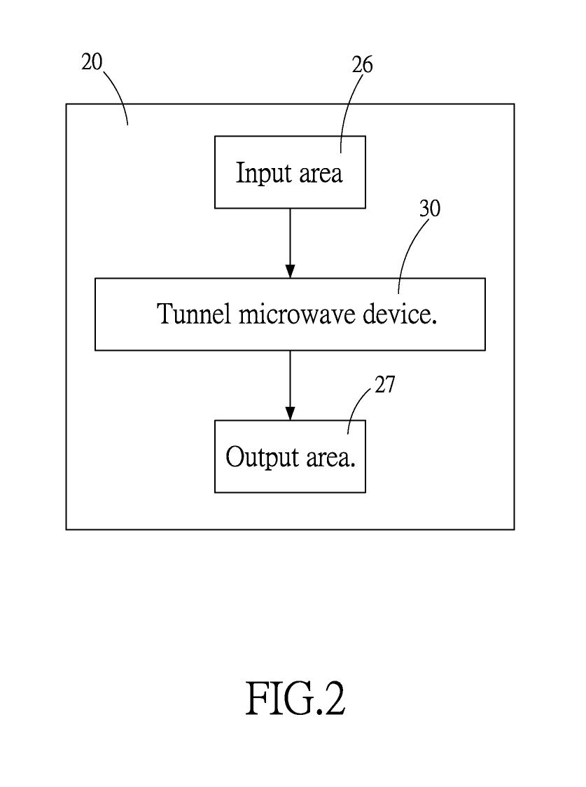

Referring to FIGS. 1-2, a fiber composite material microwave curing device with an endless conveyor belt 20 in accordance with a preferred embodiment of the present invention is used to cure the to-be-treated object (such as fiber cloth) 70, and comprises: the conveyor belt 20 and a tunnel microwave device 30.

The conveyor belt 20 is a track type conveyor belt and includes a belt 21 mounted on two rotary shafts 22, 23. The rotary shaft 22 is driven to rotate by a motor 24, so that the upper portion of the belt 21 of the conveyor belt 20 is used to carry the to-be-treated object 70, and the lower portion of the belt 21 moves oppositely to the upper portion of the belt 21. Between the two rotary shafts 22, 23 are disposed plural bearings 25 to support the belt 21. The upper portion of the belt 21 of the conveyor belt 20 is provided with an input area 26 and an output area 27 which are located at two sides of the upper portion of the belt 21 of the conveyor belt 20. The tunnel microwave device 30 is disposed above the conveyor belt 20 and has a length ranging from 0.5 to 4 m.

The tunnel microwave device 30 is disposed above the upper portion of the belt 21 of the conveyor belt 20 and located between the input and output areas 26, 27. The tunnel microwave device 30 is arc-shaped to form an input port 31 and an output port 32 which are located toward the input and output areas 26, 27, respectively. The tunnel microwave device 30 is capable of heating the to-be-treated object 70 passing through the tunnel microwave device 30 to 80-400° C. within 5-30 seconds.

The to-be-treated object 70 includes a mold 72 filled with a fiber cloth containing an impregnated material, the impregnated material is a thermosetting material, and the mold 72 is then covered with a sealing bag 73 which is vacuumed to a rough vacuum state.

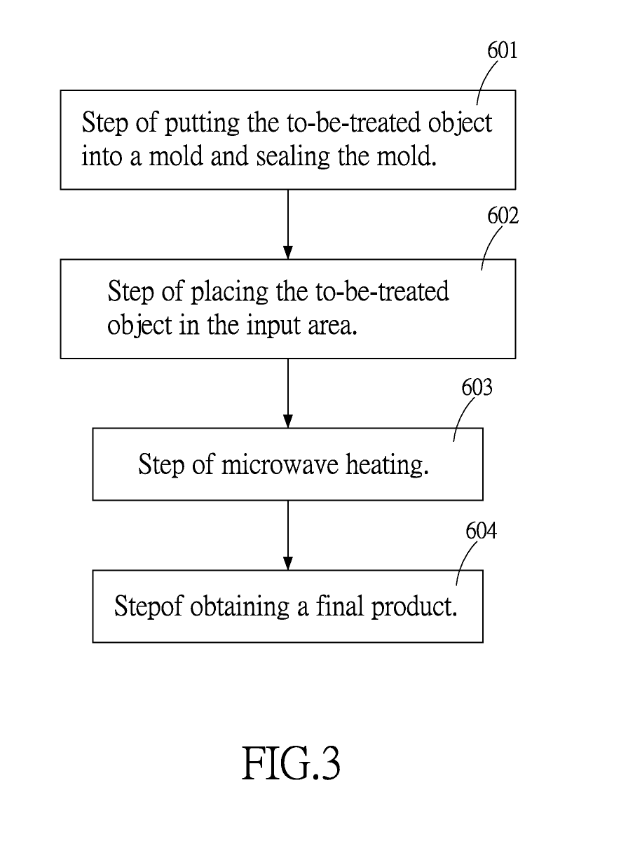

What mentioned above are the structures of the first preferred embodiment of the present invention, for a better understanding of the steps of a method for curing fiber composite material using the microwave curing device with the endless conveyor belt 20 in accordance with the invention, reference should be had to FIGS. 1-3 and the following descriptive matter. The method comprises the following steps:

A first step 601 of putting the to-be-treated object 70 into a mold 72 and sealing the mold: forming fiber composite by combination of a fiber cloth 71 and an impregnated material, putting the fiber cloth 71 containing the impregnated material into the mold 72, the impregnated material is a thermosetting material, covering the mold 72 with a sealing bag 73, and vacuuming the sealing bag 73 to a rough vacuum state;

A second step 602 of placing the to-be-treated object 70 in the input area: placing the to-be-treated object 70 which is the mold 72 vacuumed to a rough vacuum state with the sealing bag 73 in the input area 26 of the conveyor belt 20, so that the to-be-treated object 70 is moved by the conveyor belt 20 to the input port 31 of the tunnel microwave device 30;

A third step 603 of microwave heating: using the tunnel microwave device 30 to heat the to-be-treated object 70 to 80-400° C. (preferably 80-300° C). within 5-30 seconds, so as to cure the fiber cloth 71 containing the impregnated material, meanwhile, the conveyor belt 20 keeps moving at a constant speed; this step 603 can further include increasing inner pressure of the mold 72 by further vacuuming the sealing bag or by using external compression devices in a mechanical way, such as pressure rail or pressure cylinder;

A fourth step 604 of obtaining a final product: moving the to-be-treated object 70 from the output port 32 of the tunnel microwave device 30 to the output area 32 of the conveyor belt 20, taking out the mold 72 from the sealing bag 73, then taking out the final product from the mold 72. Since the composite material inside the mold is heated by variable frequency microwave, which can keep the mold in a low temperature for easy and safe removal of the final product.

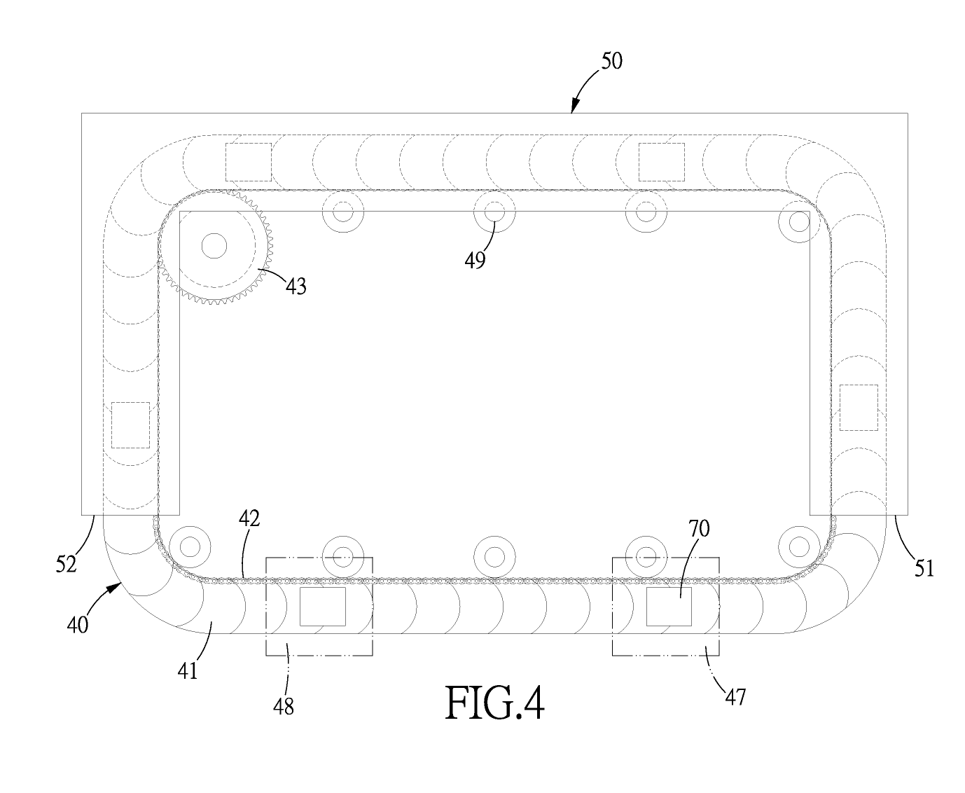

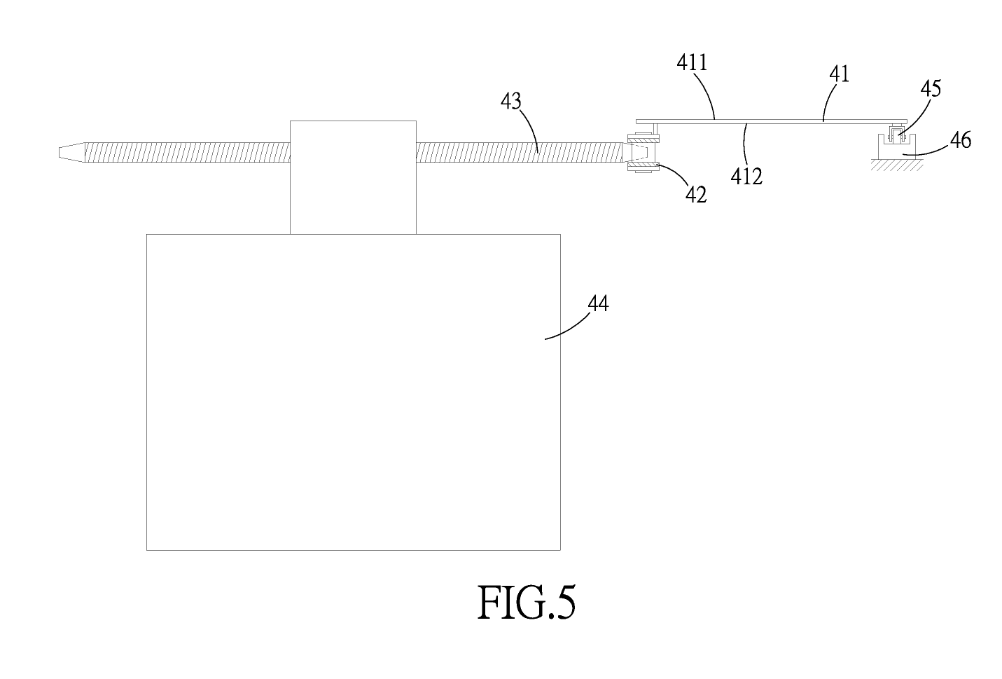

Referring then to FIGS. 4 and 5, a fiber composite material microwave curing device with an endless conveyor belt in accordance with another preferred embodiment of the present invention comprises: a conveyor belt 40 and a tunnel microwave device 50.

The conveyor belt 40 includes a plurality of carrying plates 41 connected to a chain 42 in an annular manner. The chain 42 has one end engaged with a toothed wheel 43 which is driven to rotate by a motor 44. Each of the carrying plates 41 includes a top surface 411 and a bottom surface 412, and has one side of the bottom surface 412 fixed to the chain 42. Another side of the bottom surface 412 of each of the carrying plates 41 is provided with a pulley wheel 45 which rolls along a rail 46. The tunnel microwave device 50 is disposed above the conveyor belt 40 and has a length ranging from 0.5 to 4 cm. The conveyor belt 40 includes an input area 47 and an output area 48. In this embodiment, the conveyor belt 40 as a whole is rectangular shaped and supported by a plurality of bearings 49. The input and output areas 47, 48 are disposed at one edge of the conveyor belt 40, the tunnel microwave device 50 is located between the input and output areas 47, 48, and another three edges of the conveyor belt 40 define a U shape. The tunnel microwave device 50 is arc-shaped to form an input port 51 and an output port 52 which are located toward the input and output areas 47, 48, respectively. The shape of the chain 42 can be adjusted to fit the conveyor belt 40 to form different conveyor paths of different shapes.

While we have shown and described various embodiments in accordance with the present invention, it is clear to those skilled in the art that further embodiments may be made without departing from the scope of the present invention.

What is claimed is:

1. A fiber composite material microwave curing device with an endless conveyor belt, comprising:
the conveyor belt driven to rotate by a motor and including an input area and an output area; and
a tunnel microwave device disposed above the upper portion of the belt of the conveyor belt and located between the input and output areas, the tunnel microwave device being arc-shaped to form an input port and an output port which are located toward the input and output areas, respectively.

2. The fiber composite material microwave curing device with the endless conveyor belt as claimed in claim 1, wherein the conveyor belt is a track type conveyor belt and includes a belt mounted on two rotary shafts, one of the rotary shafts is driven to rotate by the motor, between the two rotary shafts are disposed plural bearings to support the belt, the input and output areas are located at two sides of an upper portion of the belt, and the tunnel microwave device is disposed above the belt.

3. The fiber composite material microwave curing device with the endless conveyor belt as claimed in claim 1, wherein the conveyor belt includes a plurality of carrying plates fixed to a chain, the chain has one end engaged with a toothed wheel which is driven to rotate by the motor, and then the toothed wheel drives the chain to move.

4. The fiber composite material microwave curing device with the endless conveyor belt as claimed in claim 3, wherein each of the carrying plates includes a top surface and a bottom surface and has one side of the bottom surface fixed to the chain, another side of the bottom surface of each of the carrying plates is provided with a pulley wheel which rolls along a rail.

5. The fiber composite material microwave curing device with the endless conveyor belt as claimed in claim 1, wherein the tunnel microwave device has a length ranging from 0.5 to 4 m.

6. A method for curing fiber composite material using the fiber composite material microwave curing device with the endless conveyor belt as claimed in claim 1, comprising the following steps:
a first step of putting a fiber cloth containing an impregnated material into a mold, covering the mold with a sealing bag, and vacuuming the sealing bag to a rough vacuum state;
a second step of placing the mold which has been vacuumed to a rough vacuum state by the sealing bag in the input area of the conveyor belt, so that the to-be-treated object is moved by the convey belt to the input port of the tunnel microwave device;
a third step of using the tunnel microwave device to heat the mold which has been vacuumed to a rough vacuum state by the sealing bag to 80-400° C. within 5-30 seconds, so as to cure the fiber cloth containing the impregnated material; and
a fourth step of moving the mold which has been vacuumed to a rough vacuum state by the sealing bag from the output port of the tunnel microwave device to the output area of the convey belt, taking out the mold from the sealing bag, then taking out a final product from the mold.

7. The method for curing fiber composite material as claimed in claim 6, wherein the conveyor belt keeps moving at a constant speed during the third step, and the third step also increases inner pressure of the mold by further vacuuming the sealing bag or by using external compression devices in a mechanical way, including using pressure rail or pressure cylinder.

8. The method for curing fiber composite material as claimed in claim 6, wherein the mold which has been vacuumed to a rough vacuum state by the sealing bag is heated 80-300° C. during the third step, and the composite material inside the mold is heated by variable frequency microwave, the fiber cloth containing the impregnated material inside the mold is heated by variable frequency microwave.

9. The method for curing fiber composite material as claimed in claim 6, wherein the impregnated material is a thermosetting material.

10. The method for curing fiber composite material as claimed in claim 6, wherein the tunnel microwave device has a length ranging from 0.5 to 4 m.
